(19) United States
(12) Patent Application Publication
(10) Pub. No.: US 2006/0150240 A1
(43) Pub. Date: Jul. 6, 2006

(54) Application-specific network access management system

(76) Inventors: Jason Robinson, Fremont, CA (US); Brian James Ebert, San Mateo, CA (US)

Correspondence Address: PATENTRY, 300 MURCHISON DRIVE, SUITE 218, MILLBRAE, CA, 94030, US

(21) Appl. No.: 10/905,408

(22) Filed: Jan. 3, 2005

(51) Int. Cl. H04L 9/32

(52) U.S. Cl. 726/4

(57) ABSTRACT

A method of network management, enabling a user to control access by configuring network equipment, comprising discovering and selecting from a matrix of users and applications.

### BACKGROUND OF THE INVENTION

Increasingly, home computers provide access to applications that run on servers located outside of the house on equipment which are not under the control of parents. Examples are internet chat rooms, pornography sites, instant messaging, multiplayer gaming, gambling, and voice over IP. While parents can control the installation of software on computers in their home, it is difficult to limit what can be found on the Internet. Many multi-computer networks are managed through a gateway or router. While each gateway or router has an administrative user interface, they present control functionality beyond the ability of persons unskilled in the art of network programming and administration.

As computer networking continues to expand within our homes and small businesses, networks too small to employ professional administration lack tools to control or monitor use of the internet. Fundamental capabilities to do both are resident in the networking hardware itself but cannot be exploited without professional networking expertise.

Thus it can be appreciated that there is needed a method for unsophisticated owners and parents to limit access in their home without learning network programming skills.

### SUMMARY OF THE INVENTION

The present invention comprises a network management supervisor program product, a plurality of gateway and router firmware programming modules, a database of typical port numbers used by internet applications, a cockpit for selecting or deselecting access from specific computer IP addresses to specific internet applications, and a survey tool to identify the specific gateway or router managing a network and the computers that are attached to that network. The object of this invention is to raise the linguistic level of existing network traffic control. Users of the invention can employ their existing networking hardware to control network traffic using terms that users understand—applications.

This invention is a process for discovering the topology of a home local area network and by specifying the desired or undesired applications, configuring a network router without knowledge of specific network engineering concepts or training. A first step discovers the topology of the owner/responsible parent's local area network. A second step presents a simple selection menu of services or internet applications to enable or disable or a more complex system of time scheduled access. A third step synthesizes custom microcode to configure the owner/responsible parent's specific installed network management equipment. A fourth step dynamically reconfigures the installed network management equipment according to desired time access. Examination and rerouting of packets according to content is also programmed.

### DETAILED DESCRIPTION

The present invention acts as an interpreter, data gatherer, and analyst. In one embodiment implementation is distributed, but its operation is centralized at the broadband router thus simplifying the chore of controlling how multiple computers access the network. The invention uses expert analysis techniques to simplify the configuration of networks.

In one embodiment the invention enables many diverse installed routers to accomplish multiple scenarios that parents would like to see:
Block Content
Block Services based on application use

In an embodiment, the network comprises multiple PCs, a router, and a broadband connection. PC1 is considered the “Parent's PC” and PC2 is the “Kid's PC”. In the following embodiment the program product is referred to as Squash:
PC2 opens Yahoo Messenger and logs in, sends message to Squash test account
PC2 browses web via Google search on “squash”
PC1 opens web browser
PC1 navigates to Squash website
PC1 chooses to download Squash
PC1 then views Squash Intro Screen
PC1 selects “Detect and Scan Network”
PC1 receives map and bullet-point analysis of network scan
PC1 selects OK and save
PC1 returns to main screen
PC1 selects “Setup Blocking”
PC1 selects “Instant Messaging”
PC1 selects “Block All Instant Messenger Clients”
PC1 selects “No, I only want to block certain PCs”
PC1 selects “Kid's PC”
PC1 selects “email”
PC1 selects “Block All Instant Messenger Clients”
PC1 selects “No, I only want to block certain PCs”
PC1 selects “Kid's PC”
PC1 selects “OK and save”
PC2 shows Yahoo Messenger connection is inactive
PC1 selects “Setup Blocking”
PC1 selects “Content”
PC1 reviews predefined list of content that is already blocked
PC1 clicks “Add Word”
PC1 enters “squash”
PC1 clicks “OK and save”
PC2 tries to navigate using searches on Google for sites with “squash” and gets blocked

### DESCRIPTION OF THE FIGURES

FIG. 1 “Welcome” is a screen image of an introductory top level control panel for a user of one embodiment of the invention.

FIG. 2 “Network Survey” is a screen image of the result of analyzing the network and a control panel in one embodiment of the invention.

FIG. 3 “Block Applications” is a screen image of a application blocking control panel in one embodiment of the invention

FIG. 4 “Content Filtering” is a screen image of a text entry user interface to block websites with specific textual content.

FIG. 5 “Flow State Machine” is a flow diagram of the major functions of the invention and the steps within each major function illustrating the organization of user operations and user interface screens in one embodiment of the invention.

FIG. 6 “Data Flow Diagram” is a schematic showing the major elements that comprise the invention and the interaction among the major elements.

### DETAILED DESCRIPTION

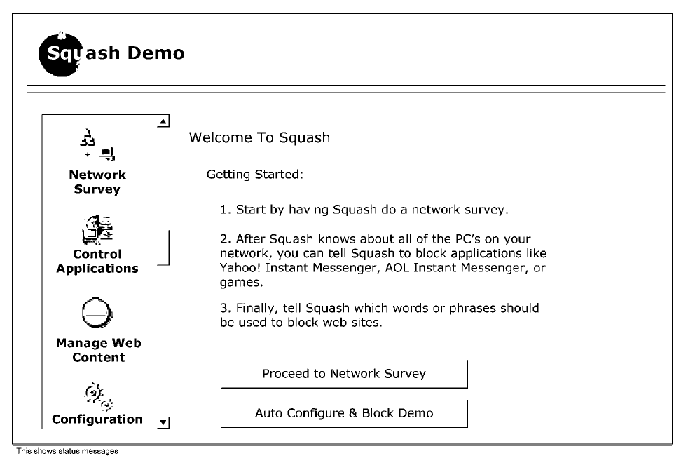

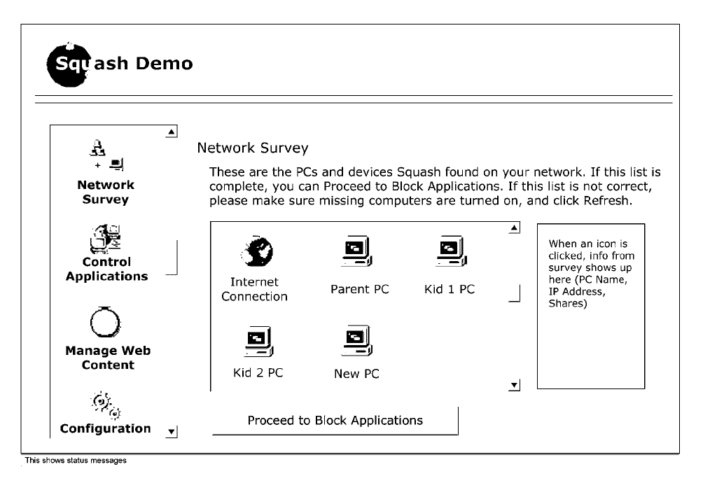

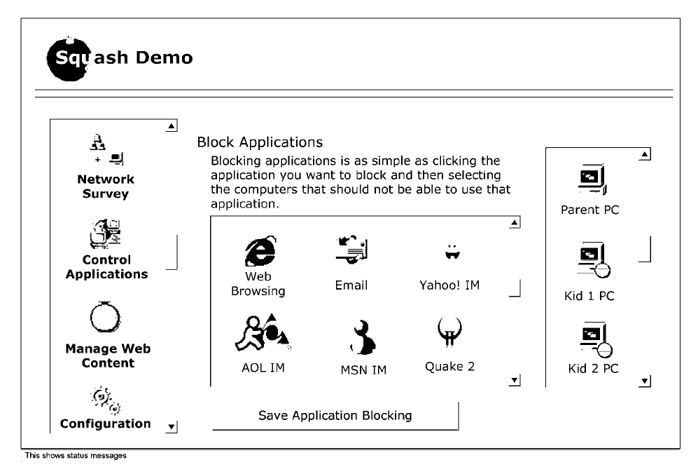

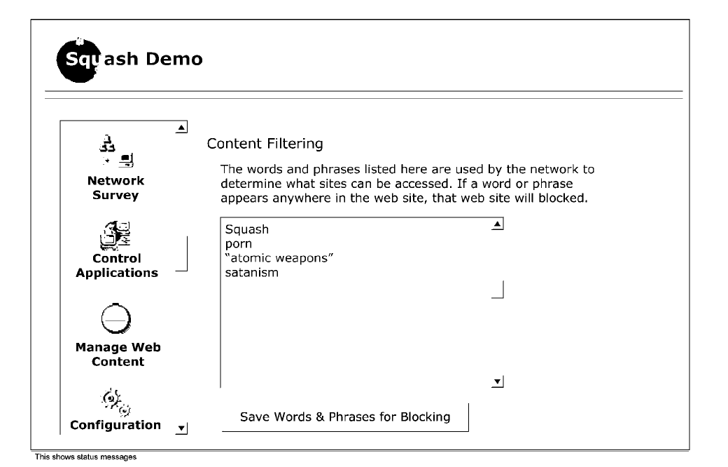

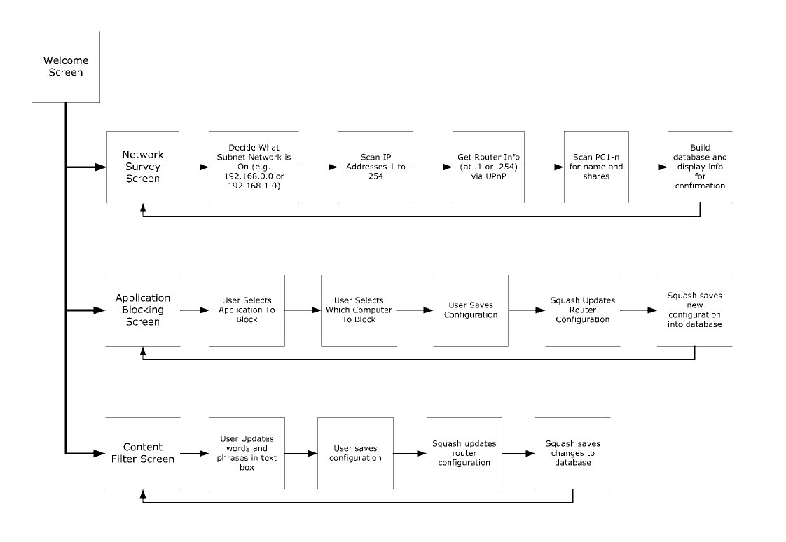

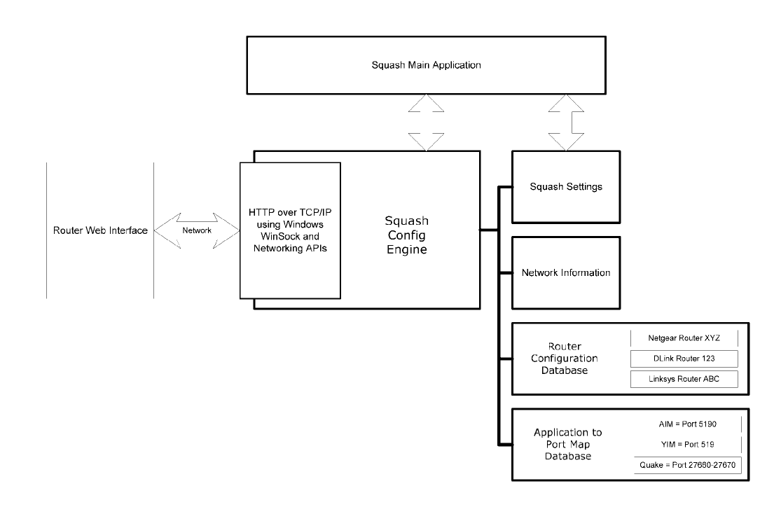

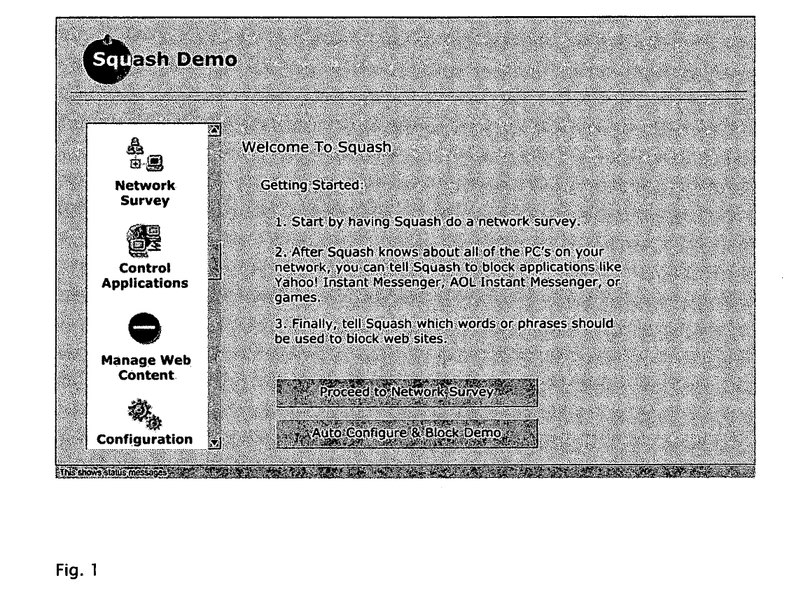

Referring now to the figures, FIG. 1 is a welcome screen that shows the overall functionality on the left panel, comprising Network Survey, Control Applications, Manage Web Content, and Configuration. Instructions and buttons are provided for new users to get started.

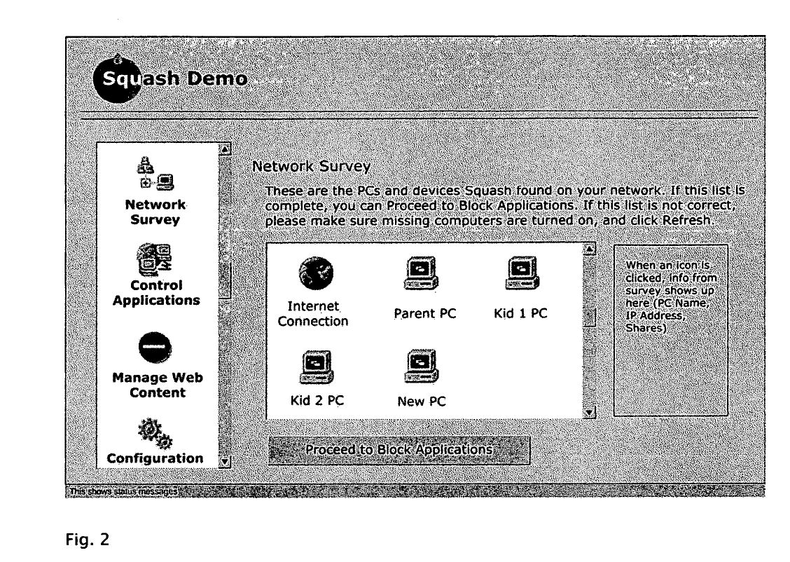

FIG. 2 shows the addition of the specific user interface of the Network Survey function on the center panel with instructions in the right panel. The network servey has placed icons and names for each of the pc's found in the users network. This is more recognizable and familiar than IP addresses.

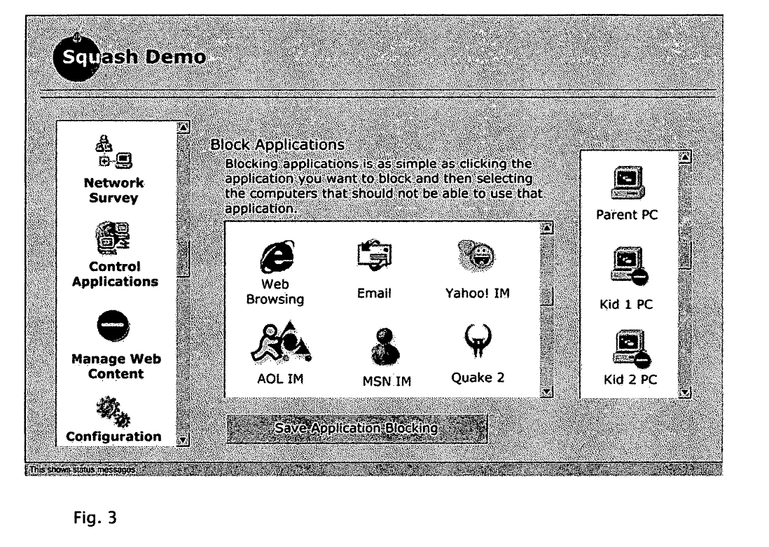

FIG. 3 shows the functionality of Control Application. In one embodiment, the owner or responsible parent selects the application and then those pc's that will be enabled or disabled. In an alternate embodiment, the owner or responsible parent selects a specific pc and then enables or disables applications. This replaces the need for someone skilled in the art of network programming to know the port numbers associated with each application and the IP address of each node as well as the advanced functionality of the specific gateway or router.

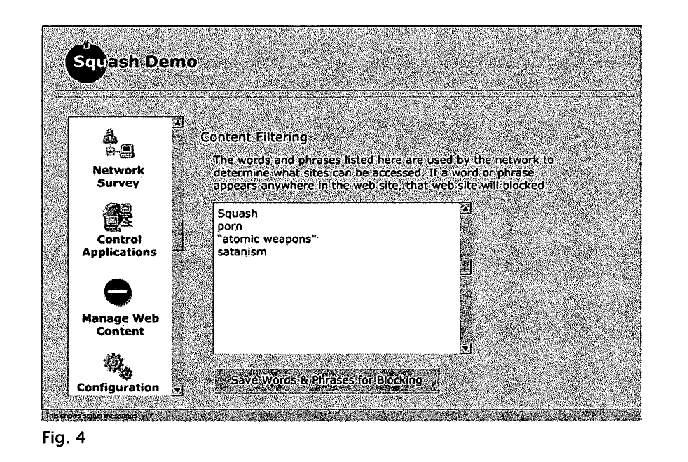

FIG. 4 shows one embodiment of Managing Web Content or Content Filtering. The text is self-explanatory: The words and phrases listed here are used by the network to determine what sites can be accessed. If a word or phrase appears anywhere in the web site, that web site will be blocked.

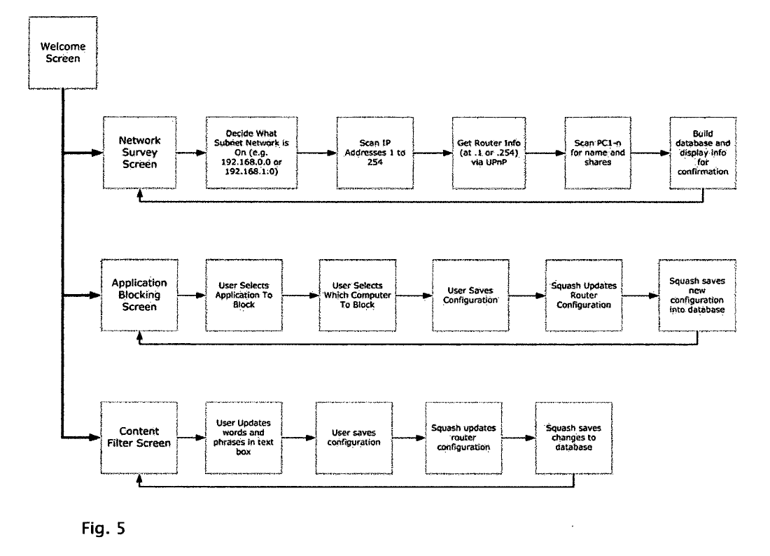

FIG. 5 shows an embodiment of the invention as a control flow chart suitable for one skilled in the art of computer programming to implement the invention as a series of steps comprising:

For Network Survey, the steps of
Decide what subnet network is on
Scan IP addresses 1 to 254
Get router Info via UPnP
Scan PC1-n for name and shares
Build database and display info for confirmation
For Application Blocking, the steps of
User selects application to block
User selects which computer to block
User saves configuration
Squash updates router configuration
Squash saves new configuration into database

For Content Filtering, the steps of
User updates words and phrases in text box
User saves configuration
Squash updates router configuration
Squash saves changes to database

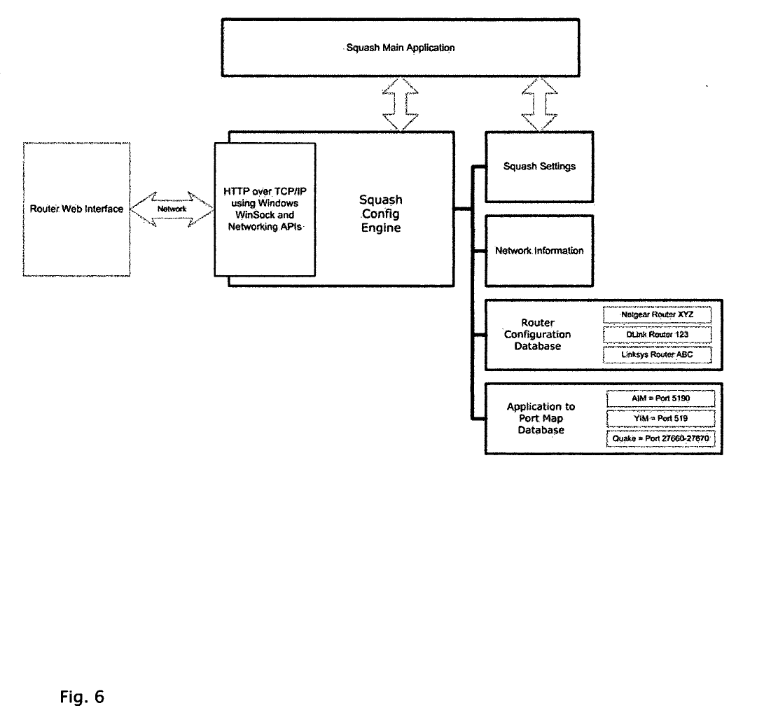

FIG. 6 shows an embodiment of the invention as a data flow diagram suitable for one skilled in the art of computer programming to implement the invention as a system comprising a Squash Configuration Engine having access to Squash Settings, Network Information, Router Configuration Database, Application to Port Map Database, and via HTTP over TCP/IP using Windows Winsock and Networking APIs, the Router Web Interface. The main user graphical interface is the Squash Main Application presenting and receiving data with the Squash Configuration Engine and with the Squash Settings. It should be noted that the Application to Port Map Database will change over time as new applications are introduced and others may change their preferred Port Numbers and the user of the invention will obtain updates for the Application to Port Map Database. The Squash Configuration Engine will maintain exclusive control over the Router Web Interface to prevent anyone other than the owner or responsible parent from changing application enablement or content filters.

### EMBODIMENTS

One way to manage network security and accessibility to external internet services and applications, is
requesting from a remote server a downloadable network discovery surveyor,
requesting from a remote server downloadable code fragments and port numbers according to the results of the operation of the network discovery surveyor,
assembling a unique selection application for the owner/responsible parent of the network to choose to enable or disable access from his network to external internet applications,
compiling microcode according to the selection by the owner/responsible parent to control the hardware of the network equipment to reflect the configuration choices by means of port numbers, and
configuring the network by programming the network hardware to enable or disable port numbers.

A network discovery surveyor would identify all participating nodes on a local area network in terms other than their ip or mac addresses such as user's names or manufacturer names.

A selection application builds a table of common applications by name as well as those encountered by the discovery surveyor on pc's and nodes in the network and builds a selection screen for the owner/responsible parent to select enablement or schedule accessibility and converts the selection to port number or process type.

The process of compiling microcode would entail
creating a command sequence to put the network hardware into and out of protected configuration mode,
assembling a table of port numbers that should be always enabled according to the owner/responsible parent's selection of applications
assembling a table of port numbers that should be always disabled according to the owner/responsible parent's selection of applications
assembling a list of text strings that would cause an application to be blocked according to the owner/responsible parents direction, and
creating additional command sequences which change access to specific ports according to a schedule specified by the owner/responsible parent.

The process of configuring the network includes:
disabling port numbers typically used by Internet applications according to user's selection of enabling or disabling the applications by name,
emitting an explanatory message to user when traffic to a disabled port number occurs so that it is not perceived as unscheduled outage,
enabling specific pc or appliances to exchange information through specific port numbers to limit access to Internet applications and services,
blocking access to port numbers when packets contain strings specified by the owner/responsible parent,
emitting an explanatory message to user when ports have been blocked so that it is not perceived as low quality of service,
comparing current timestamp with owner/responsible parent's selection of windows of access to specific Internet applications and enabling or disabling port numbers through the router, and
scheduling the execution of configuration processes according to the time windows selected by the owner/responsible parent for changing accessibility to Internet applications and services.

Another embodiment is a process of first identifying the computers on a network, and second selecting from a list of network applications that pass data through a router, or gateway, and thirdly, closing or opening ports on the router, or gateway by time, by content, or by computer, thereby controlling access without the need for advanced network programming skill.

Another embodiment of the invention which configures and administers a computer network consists of the steps of
surveying the network for resources and applications,
downloading from a database a current matrix of port numbers and applications,
presenting to the owner or parent a matrix of likely internet applications for selection or deselection, and receiving selection or deselection data,
reading from a storage server appropriate code and compiling configuration code to configure the network, and
programmatically changing the port authorizations of the network gateway, or router to enable or disable access to internet based applications to fulfill the selections on said matrix.

The best mode of delivering the invention is in a computer program product on stored media consisting of machine readable and executable instructions comprising the following:
instructions to log in and obtain administrative control over a network management device and its network of local nodes,
instructions to obtain from an external server an updated mapping of applications to specific port numbers, and
instructions to select from a matrix of user nodes and applications and further compile instructions corresponding to those applications which control access over specific port numbers at particular times or on particular members of the network.

What is claimed is:

1. A method, to manage network security and accessibility to external internet services and applications, comprising the steps of
i. requesting from a remote server a downloadable network discovery surveyor,
ii. requesting from a remote server downloadable code fragments and port numbers according to the results of the operation of the network discovery surveyor,
iii. assembling a unique selection application for the owner/responsible parent of the network to choose to enable or disable access from his network to external internet applications,
iv. compiling microcode according to the selection by the owner/responsible parent to control the hardware of the network equipment to reflect the configuration choices by means of port numbers, and
v. configuring the network by programming the network hardware to enable or disable port numbers.

2. The network discovery surveyor of claim one, comprising a process of identifying all participating nodes on a local area network in terms other than their ip or mac addresses such as user's names or manufacturer names.

3. The selection application of claim one, comprising a process which builds a table of common applications by name as well as those encountered by the discovery surveyor on pc's and nodes in the network and builds a selection screen for the owner/responsible parent to select enablement or schedule accessibility and converts the selection to port number or process type.

4. The process of compiling microcode of claim one, comprising steps of:
i. creating a command sequence to put the network hardware into and out of protected configuration mode,
ii. assembling a table of port numbers that should be always enabled according to the owner/responsible parent's selection of applications
iii. assembling a table of port numbers that should be always disabled according to the owner/responsible parent's selection of applications
iv. assembling a list of text strings that would cause an application to be blocked according to the owner/responsible parents direction, and
v. creating additional command sequences which change access to specific ports according to a schedule specified by the owner/responsible parent.

5. The process of configuring the network of claim one, comprising steps of:
i. disabling port numbers typically used by Internet applications according to user's selection of enabling or disabling the applications by name,
ii. emitting an explanatory message to user when traffic to a disabled port number occurs so that it is not perceived as unscheduled outage,
iii. enabling specific pc or appliances to exchange information through specific port numbers to limit access to Internet applications and services,
iv. blocking access to port numbers when packets contain strings specified by the owner/responsible parent,
v. emitting an explanatory message to user when ports have been blocked so that it is not perceived as low quality of service,
vi. comparing current timestamp with owner/responsible parent's selection of windows of access to specific Internet applications and enabling or disabling port numbers through the router, and
vii. scheduling the execution of configuration processes according to the time windows selected by the owner/responsible parent for changing accessibility to Internet applications and services.

6. A method for configuring and administrating a computer network consisting of the steps of
i. surveying the network for resources and applications,
ii. downloading from a database a current matrix of port numbers and applications,
iii. presenting to the owner or parent a matrix of likely internet applications for selection or deselection, and receiving selection or deselection data,
iv. reading from a storage server appropriate code and compiling configuration code to configure the network, and
v. programmatically changing the port authorizations of the network gateway, or router to enable or disable access to internet based applications to fulfill the selections on said matrix by time, by content, or by computer, thereby controlling access without the need for advanced network programming skill.

7. A computer program product on stored media consisting of machine readable and executable instructions comprising the following:
i. instructions to log in and obtain administrative control over a network management device and its network of local nodes,
ii. instructions to obtain from an external server an updated mapping of applications to specific port numbers, and
iii. instructions to select from a matrix of user nodes and applications and further compile instructions corresponding to those applications which control access over specific port numbers at particular times or on particular members of the network.
